(19) United States
(12) Patent Application Publication
(10) Pub. No.: US 2018/0037713 A1
(43) Pub. Date: Feb. 8, 2018

(54) PROCESS FOR MAKING A FABRICATED ARTICLE FROM POLYOLEFIN

(71) Applicant: Dow Global Technologies LLC, Midland, MI (US)

(72) Inventors: Eric J. Hukkanen, Essex, MA (US); Bryan E. Barton, Lincoln University, PA (US); Gerald F. Billovits, Midland, MI (US); Weijun Wang, Midland, MI (US); Jasson T. Patton, Midland, MI (US)

(73) Assignee: Dow Global Technologies LLC, Midland, MI (US)

(21) Appl. No.: 15/551,963

(22) PCT Filed: Apr. 7, 2016
(86) PCT No.: PCT/US2016/026460

§ 371 Date: Aug. 18, 2017

Related U.S. Application Data
(60) Provisional application No. 62/153,194, filed on Apr. 27, 2015.

(51) Int. Cl. C08K 3/38; D01F 9/21; D01F 6/04; C08K 5/55; D01F 1/10

(52) U.S. Cl. CPC C08K 3/38; C08K 5/55; D01F 1/10; D01F 6/04; D01F 9/21; D01F 6/30

(57) ABSTRACT

The present disclosure describes a method for preparing a carbonized article comprising: providing an olefin resin in a melt phase; treating the olefin resin with a boron-containing species (BCS); forming a fabricated article from the treated olefin resin; crosslinking the fabricated article; stabilizing the fabricated article by air oxidation; and carbonizing the fabricated article. The present disclosure further describes a method for preparing a stabilized article.

### BACKGROUND

Previously, carbonaceous articles, such as carbon fibers, have been produced primarily from polyacrylonitrile (PAN), pitch, or cellulose precursors. The process for making carbonaceous articles begins by forming a fabricated article, such as a fiber or a film, from the precursor. Precursors may be formed into fabricated articles using standard techniques for forming or molding polymers. The fabricated article is subsequently stabilized to allow the fabricated article to substantially retain shape during the subsequent heat-processing steps; without being limited by theory, such stabilization typically involves a combination of oxidation and heat and generally results in dehydrogenation, ring formation, oxidation and crosslinking of the precursor which defines the fabricated article. The stabilized fabricated article is then converted into a carbonaceous article by heating the stabilized fabricated article in an inert atmosphere. While the general steps for producing a carbonaceous article are the same for the variety of precursors, the details of those steps vary widely depending on the chemical makeup of the selected precursor.

Polyolefins have been investigated as an alternative precursor for carbonaceous articles, but a suitable and economically viable preparation process has proven elusive. Of particular interest is identifying an economical process for preparing carbonaceous articles from polyolefin precursors. For example, maximizing mass retention during the stabilization and carbonization steps is of interest.

### STATEMENT OF INVENTION

The present disclosure describes a method for preparing a carbonized article comprising: providing an olefin resin in a melt phase; treating the olefin resin with a boron-containing species (BCS); forming a fabricated article from the treated olefin resin; crosslinking the fabricated article; stabilizing the fabricated article by air oxidation; and carbonizing the fabricated article. The present disclosure further describes a method for preparing a stabilized article.

### DETAILED DESCRIPTION

Unless otherwise indicated, numeric ranges, for instance “from 2 to 10,” are inclusive of the numbers defining the range (e.g., 2 and 10).

Unless otherwise indicated, ratios, percentages, parts, and the like are by weight.

Unless otherwise indicated, the crosslinkable functional group content for a polyolefin resin is characterized by the mol % crosslinkable functional groups, which is calculated as the number of mols of crosslinkable functional groups divided by the total number of mols of monomer units contained in the polyolefin.

Unless otherwise indicated, “monomer” refers to a molecule which can undergo polymerization, thereby contributing constitutional units to the essential structure of a macromolecule, for example, a polyolefin.

In one aspect, the present disclosure describes a process for producing a carbonaceous fabricated article from a polyolefin resin. Unless stated otherwise, any method or process steps described herein may be performed in any order. Polyolefins are a class of polymers produced from one or more olefin monomer. The polymers described herein may be formed from one or more types of monomers. Polyethylene is the preferred polyolefin resin, but other polyolefin resins may be substituted. For example, a polyolefin produced from ethylene, propylene, or other alpha-olefin (for instance, 1-butene, 1-hexene, 1-octene), or a combination thereof, is also suitable. The polyolefins described herein are typically provided in resin form, subdivided into pellets or granules of a convenient size for further melt or solution processing.

The polyolefin resin is processed to form a fabricated article. A fabricated article is an article which has been fabricated from the polyolefin resin. The fabricated article is formed using known polyolefin fabrication techniques, for example, melt or solution spinning to form fibers, film extrusion or film casting or a blown film process to form films, die extrusion or injection molding or compression molding to form more complex shapes, or solution casting. The fabrication technique is selected according to the desired geometry of the target carbonaceous article, and the desired physical properties of the same. For example, where the desired carbonaceous article is a carbon fiber, fiber spinning is a suitable fabrication technique. As another example, where the desired carbonaceous article is a carbon film, compression molding is a suitable fabrication technique.

The polyolefin resin is treated with a boron-containing species (BCS) while the resin is in the melt phase. The melt phase of the polyolefin resin is defined as a condition where the polyolefin resin is suitable for forming into a fabricated article. In one instance, the melt phase is achieved by heating the resin to a temperature range where the solid resin transitions to a liquid, which temperature range will vary depending on the composition of the selected polyolefin resin, as is known in the art. In one instance, the BCS is added to the melt phase resin. In another instance, the BCS is introduced to the resin during the fabrication process. In another instance, the BCS and the resin are dry blended prior to forming a melt phase; for example, the BCS can be introduced as a masterbatch or neat. The polyolefin is treated with the BCS such that boron is contained in the fabricated article following fabrication. Any suitable BCS which deposits boron in the fabricated article may be used. In one instance, the BCS is an organoborane. In one instance, boric acid is used as the BCS. In one instance the BCS is a derivative of boric acid, for example, metaboric acid and boron oxide. In one instance, the BCS is a derivative of boronic acid, for example, a substituted boronic acid (for example, alkyl substituted, such as methyl-, or ethyl-, or aryl substituted, such as phenyl-). In one instance, the BCS is a derivative of borinic acid, for example, a substituted borinic acid (for example, alkyl substituted, such as methyl-, or ethyl-, or aryl substituted, such as phenyl-). In another instance, the BCS is a derivative of borane, boronic ester or boroxine. In another instance, the BCS is elemental boron. In another instance, the BCS is a derivative of borazine, borohydride, or aminoborane.

The polyolefin resins described herein are subjected to a crosslinking step. Any suitable method for crosslinking polyolefins is sufficient. In one instance, the polyolefins are crosslinked by irradiation, such as by electron beam processing. Other crosslinking methods are suitable, for example, ultraviolet irradiation and gamma irradiation. In some instances, an initiator, such as benzophenone, may be used in conjunction with the irradiation to initiate crosslinking. In one instance, the polyolefin resins have been modified to include crosslinkable functional groups which are suitable for reacting to crosslink the polyolefin resin. Where the polyolefin resin includes crosslinkable functional groups, crosslinking may be initiated by known methods, including use of a chemical crosslinking agent, by heat, by steam, or other suitable method. In one instance, copolymers are suitable to provide a polyolefin resin having crosslinkable functional groups where one or more alpha-olefins have been copolymerized with another monomer containing a group suitable for serving as a crosslinkable functional group, for example, dienes, carbon monoxide, glycidyl methacrylate, acrylic acid, vinyl acetate, maleic anhydride, or vinyl trimethoxy silane (VTMS) are among the monomers suitable for being copolymerized with the alpha-olefin. Further, the polyolefin resin having crosslinkable functional groups may also be produced from a poly(alpha-olefin) which has been modified by grafting a functional group moiety onto the base polyolefin, wherein the functional group is selected based on its ability to subsequently enable crosslinking of the given polyolefin. For example, grafting of this type may be carried out by use of free radical initiators (such as peroxides) and vinyl monomers (such as VTMS, dienes, vinyl acetate, acrylic acid, methacrylic acid, acrylic and methacrylic esters such as glycidyl methacrylate and methacryloxypropyl trimethoxysilane, allyl amine, p-aminostyrene, dimethylaminoethyl methacrylate) or via azido-functionalized molecules (such as 4-[2-(trimethoxysilyl)ethyll]benzenesulfonyl azide). Polyolefin resins having crosslinkable functional groups may be produced from a polyolefin resin, or may be purchased commercially. Examples of commercially available polyolefin resins having crosslinkable functional groups include SI-LINK sold by The Dow Chemical Company, PRIMACOR sold by The Dow Chemical Company, EVAL resins sold by Kuraray, and LOTADER AX8840 sold by Arkema.

As noted above, at least a portion of the polyolefin resin is crosslinked to yield a crosslinked fabricated article. In some embodiments, crosslinking is carried out via chemical crosslinking. Thus, in some embodiments, the crosslinked fabricated article is a fabricated article which has been treated with one or more chemical agents to crosslink the crosslinkable functional groups of the polyolefin resin having crosslinkable functional groups. Such chemical agent functions to initiate the formation of intramolecular chemical bonds between the crosslinkable functional groups or reacts with the crosslinkable functional groups to form intramolecular chemical bonds, as is known in the art. Chemical crosslinking causes the crosslinkable functional groups to react to form new bonds, forming linkages between the various polymer chains which define the polyolefin resin having crosslinkable functional groups. The chemical agent which effectuates the crosslinking is selected based on the type of crosslinkable functional group(s) included in the polyolefin resin; a diverse array of reactions are known which crosslink crosslinkable functional groups via intermolecular and intramolecular chemical bonds. A suitable chemical agent is selected which is known to crosslink the crosslinkable functional groups present in the fabricated article to produce the crosslinked fabricated article. For example, without limiting the present disclosure, if the crosslinkable functional group attached to the polyolefin is a vinyl group, suitable chemical agents include free radical initiators such as peroxides or azo-bis nitriles, for example, dicumyl peroxide, dibenzoyl peroxide, t-butyl peroctoate, azobisisobutyronitrile, and the like. If the crosslinkable functional group attached to the polyolefin is an acid, such as a carboxylic acid, or an anhydride, or an ester, or a glycidoxy group, a suitable chemical agent can be a compound containing at least two nucleophilic groups, including dinucleophiles such as diamines, diols, dithiols, for example ethylenediamine, hexamethylenediamine, butane diol, or hexanedithiol. Compounds containing more than two nucleophilic groups, for example glycerol, sorbitol, or hexamethylene tetramine can also be used. Mixed di- or higher-nucleophiles, which contain at least two different nucleophilic groups, for example ethanolamine can also be suitable chemical agents. If the crosslinkable functional group attached to the polyolefin is a mono-, di- or tri-alkoxy silyl group, water, and Lewis or Bronsted acid or base catalysts can be used as suitable chemical agents. For example, without limiting the present disclosure, Lewis or Bronsted acid or base catalysts include aryl sulfonic acids, sulfuric acid, hydroxides, zirconium alkoxides or tin reagents.

Crosslinking the fabricated article is generally preferred to ensure that the fabricated article retains its shape at the elevated temperatures required for the subsequent processing steps. Without crosslinking, polyolefin resins typically soften, melt or otherwise deform or breakdown at elevated temperatures. Crosslinking adds thermal stability to the fabricated article.

The crosslinked fabricated article is heated in an oxidizing environment to yield a stabilized fabricated article. In some embodiments, the temperature for stabilizing the crosslinked fabricated article is at least 120° C., preferably at least 190° C. In some embodiments, the temperature for stabilizing the crosslinked fabricated article is no more than 400° C., preferably no more than 300° C. In one instance, the crosslinked fabricated article is introduced to a heating chamber which is already at the desired temperature. In another instance, the fabricated article is introduced to a heating chamber at or near ambient temperature, which chamber is subsequently heated to the desired temperature. In some embodiments the heating rate is at least 1° C./minute. In other embodiments the heating rate is no more than 15° C./minute. In yet another instance, the chamber is heated step wise, for instance, the chamber is heated to a first temperature for a time, such as, 120° C. for one hour, then is raised to a second temperature for a time, such as 180° C. for one hour, and third is raised to a holding temperature, such as 250° C. for 10 hours. The stabilization process involves holding the crosslinked fabricated article at the given temperature for periods up to 100 hours depending on the dimensions of the fabricated article. The stabilization process yields a boron-treated stabilized fabricated article which is a precursor for a carbonaceous article. Without being limited by theory, the stabilization process oxidizes the crosslinked fabricated article and causes changes to the hydrocarbon structure that increases the crosslink density while decreasing the hydrogen/carbon ratio of the crosslinked fabricated article. Without being limited by theory, the stabilization process introduces boron to the hydrocarbon structure.

Unexpectedly, it has been found that including a BCS in the fabricated article during the stabilization step improves mass retention of the subsequently produced carbonaceous article. It has also been found that incorporating boron in the crosslinked fabricated article improves form-retention of the subsequently produced carbonaceous article.

In another aspect, the present disclosure describes a boron-treated stabilized fabricated article which is formed from a polyolefin precursor (resin). In one instance, the boron-treated stabilized fabricated article is formed according to the process described herein.

In yet another aspect, a carbonaceous article and a process for making the same are provided. Carbonaceous articles are articles which are rich in carbon; carbon fibers, carbon sheets and carbon films are examples of carbonaceous articles. Carbonaceous articles have many applications, for example, carbon fibers are commonly used to reinforce composite materials, such as in carbon fiber reinforced epoxy composites, while carbon discs or pads are used for high performance braking systems.

The carbonaceous articles described herein are prepared by carbonizing the stabilized fabricated article by heat-treating the boron-treated stabilized fabricated articles in an inert environment. The inert environment is an environment surrounding the boron-treated stabilized fabricated article that shows little reactivity with carbon at elevated temperatures, preferably a high vacuum or an oxygen-depleted atmosphere, more preferably a nitrogen atmosphere or an argon atmosphere. It is understood that trace amounts of oxygen may be present in the inert atmosphere. In one instance, the temperature of the inert environment is at or above 600° C. Preferably, the temperature of the inert environment is at or above 800° C. In one instance, the temperature of the inert environment is no more than 3000° C. In one instance, the temperature is from 1400-2400° C. Temperatures at or near the upper end of that range will produce a graphite article, while temperatures at or near the lower end of the range will produce a carbon article.

In order to prevent bubbling or damage to the fabricated article during carbonization, it is preferred to heat the inert environment in a gradual or stepwise fashion. In one embodiment, the boron-treated stabilized fabricated article is introduced to a heating chamber containing an inert environment at or near ambient temperature, which chamber is subsequently heated over a period of time to achieve the desired final temperature. The heating schedule can also include one or more hold steps for a prescribed period at the final temperature or an intermediate temperature or a programmed cooling rate before the article is removed from the chamber.

In yet another embodiment, the chamber containing the inert environment is subdivided into multiple zones, each maintained at a desired temperature by an appropriate control device, and the boron-treated stabilized fabricated article is heated in a stepwise fashion by passage from one zone to the next via an appropriate transport mechanism, such as a motorized belt. In the instance where a boron-treated stabilized fabricated article is a fiber, this transport mechanism can be the application of a traction force to the fiber at the exit of the carbonization process while the tension in the stabilized fiber is controlled at the inlet. Some embodiments of the invention will now be described in detail in the following Examples.

In the Examples, overall mass yield is calculated as the product of oxidation mass yield and carbonization mass yield. PHR refers to parts per hundred resin (mass basis). MI refers to melt index which is a measure of melt flow rate. Definitions of measured yields:

Oxidation mass yield:

$${Y}_{O} = \frac{{m}_{OX}}{{m}_{PE}}$$

Carbonization mass yield:

$${Y}_{C} = \frac{{m}_{CF}}{{m}_{OX}}$$

Overall mass yield: Y_{M}=Y_{O}Y_{C}

Overall mass yield (carbonaceous mass per initial mass of PE):

$${Y}_{M , PE} = \frac{{Y}_{O} {Y}_{C}}{{M}_{\% PE}}$$

Where m_{PE} is the initial mass of polyethylene; m_{OX} is the mass remaining after oxidation; m_{CF} is the mass remaining after carbonization; M_{% PE} is the mass % of polyethylene in the origin formed article.

Soxhlet extraction is a method for determining the gel content and swell ration of crosslinked ethylene plastics, also referred to herein as hot xylenes extraction. As used herein, Soxhlet extraction is conducted according to ASTM Standard D2765-11 “Standard Test Methods for Determination of Gel Content and Swell Ratio of Crosslinked Ethylene Plastics.” In the method employed, a crosslinked fabricated article between 0.050-0.500 g is weighed and placed into a cellulose-based thimble which is then placed into a Soxhlet extraction apparatus with sufficient quantity of xylenes. Soxhlet extraction is then performed with refluxing xylenes for at least 12 hours. Following extraction, the thimbles are removed and the crosslinked fabricated article is dried in a vacuum oven at 80° C. for at least 12 hours and then weighed, thereby providing a Soxhlet-treated article. The gel content (%) is then calculated from the weight ratio (Soxhlet-treated article)/(crosslinked fabricated article).

### Comparative Example 1

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Gel fraction was determined to be 35.5% by Soxhlet extraction. Three (3) smaller circular films are sectioned from the prepared films and weighed. Films were oxidized in a convection oven at 250° C. for 10 hours under air environment (21% oxygen content). The three (3) films were weighed after air oxidation. Mass retention during air oxidation (oxidation mass yield) is reported in Table I. Oxidized films are then carbonized in nitrogen environment from 25° C. to 800° C. using a ramp rate of 10° C./min. Mass retention during carbonization (carbonization mass yield) is reported in Table I. Calculated overall mass yield is reported in Table I.

TABLE I

| | Oxidation Mass | Carbonization | Overall Mass |
|---|---|---|---|
| Example | Yield (%) | Mass Yield (%) | Yield (%) |
| A | 36.24 | 43.96 | 15.93 |
| B | 34.19 | 46.64 | 15.94 |
| C | 32.42 | 47.19 | 15.30 |

### Example 1

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) and varying portions of boric acid, as reported in

Table II, at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Two (2) smaller circular films for each boric acid loading are sectioned from the prepared films and weighed. Films are oxidized in a convection oven at 250° C. for 10 hours under air environment (21% oxygen content). Two (2) films were weighed after air oxidation. Mass retention during air oxidation (oxidation mass yield) is reported in Table III. Oxidized films were then carbonized in nitrogen environment from 25° C. to 800° C. using a ramp rate of 10° C./min. Mass retention during carbonization (carbonization mass yield) is reported in Table III. Calculated overall mass yield and overall PE mass yield is reported in Table III.

TABLE II

| Example | Esacure One (phr) | Boric Acid (phr) |
|---|---|---|
| A | 2.04 | 20.41 |
| B | 2.04 | 20.41 |
| C | 2.04 | 18.37 |
| D | 2.04 | 18.37 |
| E | 2.04 | 16.33 |
| F | 2.04 | 16.33 |
| G | 2.04 | 14.29 |
| H | 2.04 | 14.29 |
| I | 2.04 | 12.24 |
| J | 2.04 | 12.24 |
| K | 2.04 | 10.20 |
| L | 2.04 | 10.20 |
| M | 2.04 | 8.16 |
| N | 2.04 | 8.16 |
| O | 2.04 | 6.12 |
| P | 2.04 | 6.12 |
| Q | 2.04 | 4.08 |
| R | 2.04 | 4.08 |
| S | 2.04 | 2.04 |
| T | 2.04 | 2.04 |

TABLE III

| | | | | Overall |
|---|---|---|---|---|
| | Oxidation mass | Carbonization | Overall Mass | PE Mass |
| Example | yield (%) | mass yield (%) | Yield (%) | Yield (%) |
| A | 77.35 | 50.82 | 39.31 | 47.33 |
| B | 78.17 | 45.82 | 35.82 | 43.13 |
| C | 71.42 | 53.87 | 38.47 | 45.54 |
| D | 71.05 | 53.62 | 38.10 | 45.10 |
| E | 77.39 | 52.12 | 40.34 | 46.92 |
| F | 76.62 | 51.74 | 39.64 | 46.12 |
| G | 84.28 | 46.29 | 39.01 | 44.58 |
| H | 78.61 | 52.98 | 41.65 | 47.60 |
| I | 72.61 | 55.65 | 40.41 | 45.36 |
| J | 73.68 | 54.40 | 40.08 | 44.99 |
| K | 83.45 | 47.85 | 39.93 | 44.01 |
| L | 75.74 | 43.77 | 33.15 | 36.53 |
| M | 79.63 | 49.83 | 39.68 | 42.92 |
| N | 74.89 | 52.29 | 39.16 | 42.36 |
| O | 74.20 | 53.38 | 39.61 | 42.03 |
| P | 69.42 | 50.03 | 34.73 | 36.86 |
| Q | 69.98 | 40.13 | 28.08 | 29.23 |
| R | 73.71 | 51.67 | 38.09 | 39.64 |
| S | 67.66 | 47.34 | 32.03 | 32.68 |
| T | 64.81 | 51.80 | 33.57 | 34.26 |

It is observed that mean oxidation mass yield of A-T (Example 1) increases by 89.1-146% when crosslinked films of polyethylene are melt blended with varying loadings of boric acid are oxidized when compared to A-C(Comparative Example 1). Further, it is observed that mean overall mass yield of A-T (Example 1) increases by 78.6-165% when crosslinked films of polyethylene melt blended with varying loadings of boric acid are oxidized and carbonized when compared to A-C(Comparative Example 1). Additionally, it is observed that mean overall polyethylene mass yield of A-T (Example 1) increases by 85.9-203% when crosslinked films of polyethylene melt blended with varying loadings of boric acid are oxidized and carbonized when compared to A-C(Comparative Example 1).

### Comparative Example 2

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) at 180° C. in a Haake mixer under nitrogen. Suitable films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Gel fraction is determined to be 35.5% by Soxhlet extraction. Two (2) smaller circular films are sectioned and weighed. Films are oxidized in a convection oven at 270° C. for 10 hours under air environment (21% oxygen content). Two (2) films are weighed after air oxidation. Mass retention during air oxidation (oxidation mass yield) is reported in Table IV. Oxidized films are then carbonized in nitrogen environment from 25° C. to 800° C. using a ramp rate of 10° C./min. Mass retention during carbonization (carbonization mass yield) is reported in Table IV. Calculated overall mass yield is reported in Table IV.

TABLE IV

| | Oxidation Mass | Carbonization | Overall Mass |
|---|---|---|---|
| Example | Yield (%) | Mass Yield (%) | Yield (%) |
| A | 30.56 | 48.44 | 14.81 |
| B | 29.10 | 46.76 | 13.61 |

### Example 2

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) and varying portions of boric acid at 180° C. in a Haake mixer under nitrogen. Table V reports the boric acid loadings. Suitable films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Two (2) smaller circular films are sectioned and weighed. Films are oxidized in a convection oven at 270° C. for 10 hours under air environment (21% oxygen content). Two (2) films are weighed after air oxidation. Mass retention during air oxidation (oxidation mass yield) is reported in Table VI. Oxidized films are then carbonized in nitrogen environment from 25° C. to 800° C. using a ramp rate of 10° C./min. Mass retention during carbonization (carbonization mass yield) is reported in Table VI. Calculated overall mass yield and overall PE mass yield is reported in Table VI.

TABLE V

| Example | Esacure One (phr) | Boric Acid (phr) |
|---|---|---|
| A | 2.04 | 20.41 |
| B | 2.04 | 20.41 |
| C | 2.04 | 18.37 |
| D | 2.04 | 18.37 |
| E | 2.04 | 16.33 |
| F | 2.04 | 16.33 |
| G | 2.04 | 14.29 |
| H | 2.04 | 14.29 |
| I | 2.04 | 12.24 |
| J | 2.04 | 12.24 |
| K | 2.04 | 10.20 |
| L | 2.04 | 10.20 |
| M | 2.04 | 8.16 |
| N | 2.04 | 8.16 |
| O | 2.04 | 6.12 |
| P | 2.04 | 6.12 |
| Q | 2.04 | 4.08 |
| R | 2.04 | 4.08 |
| S | 2.04 | 2.04 |
| T | 2.04 | 2.04 |

TABLE VI

| | | | | Overall |
|---|---|---|---|---|
| | Oxidation Mass | Carbonization | Overall Mass | PE Mass |
| Example | Yield (%) | Mass Yield (%) | Yield (%) | Yield (%) |
| A | 68.06 | 50.26 | 34.21 | 41.19 |
| B | 74.38 | 51.51 | 38.31 | 46.13 |
| C | 72.87 | 53.69 | 39.12 | 46.31 |
| D | 70.32 | 47.58 | 33.46 | 39.60 |
| E | 69.00 | 53.69 | 37.04 | 43.09 |
| F | 68.39 | 53.12 | 36.33 | 42.26 |
| G | 75.71 | 47.60 | 36.04 | 41.19 |
| H | 77.61 | 53.13 | 41.24 | 47.13 |
| I | 68.18 | 44.44 | 30.30 | 34.01 |
| J | 69.69 | 55.28 | 38.53 | 43.24 |
| K | 72.15 | 46.60 | 33.62 | 37.05 |
| L | 83.21 | 38.37 | 31.93 | 35.19 |
| M | 69.20 | 44.99 | 31.13 | 33.67 |
| N | 70.77 | 51.46 | 36.42 | 39.39 |
| O | 74.92 | 56.64 | 42.44 | 45.03 |
| P | 70.90 | 55.82 | 39.58 | 42.00 |
| Q | 70.74 | 56.53 | 39.99 | 41.62 |
| R | 65.52 | 53.62 | 35.13 | 36.57 |
| S | 66.56 | 49.15 | 32.71 | 33.38 |
| T | 63.61 | 45.56 | 28.98 | 29.57 |

It is observed that mean oxidation mass yield of A-T (Example 2) increases by 113-179% when crosslinked films of polyethylene are melt blended with varying loadings of boric acid are oxidized when compared to A-B (Comparative Example 2). It is further observed that mean overall mass yield of A-T (Example 2) increases by 104-199% when crosslinked films of polyethylene are melt blended with varying loadings of boric acid are oxidized and carbonized when compared to A-B (Comparative Example 2). It is additionally observed that mean overall polyethylene mass yield of A-T (Example 2) increases by 108-232% when crosslinked films of polyethylene melt blended with varying loadings of boric acid are oxidized and carbonized when compared to A-B (Comparative Example 2).

### Comparative Example 3

A polyethylene-co-acrylic acid polymer resin containing 9.7 wt % acid (density=0.938 g/cm³; MI=20 g/10 min, 190° C./2.16 kg) was compression molded at 150° C. to form thin films measuring 3 mils (76.2 microns) by micrometer. A single smaller circular film was sectioned and weighed. The film was oxidized in a convection oven at 250° C. for 10 hours under air environment (21% oxygen content). The film was weighed after air oxidation. Mass retention during air oxidation (oxidation mass yield) is reported in Table VII. Oxidized films were then carbonized in nitrogen environment from 25° C. to 800° C. using a ramp rate of 10° C./min. Mass retention during carbonization (carbonization mass yield) is reported in Table VII. Calculated overall mass yield is reported in Table VII.

TABLE VII

| | Oxidation Mass | Carbonization | Overall Mass |
|---|---|---|---|
| Example | Yield (%) | Mass Yield (%) | Yield (%) |
| A | 52.62 | 43.45 | 22.86 |

### Example 3

A polyethylene-co-acrylic acid polymer resin containing 9.7 wt % acid (density=0.938 g/cm³; MI=20 g/10 min, 190° C./2.16 kg) is melt blended with varying portions of boric acid and Esacure ONE, a commercially available photoinitiator sold by Lambeth, at 175° C. in a Haake mixer under nitrogen. Table VIII reports the additive loadings. Suitable films are compression molded at 150° C. to form thin films measuring 3 millimeters (76.2 microns) thick by micrometer. Samples A-D received no additional treatment. Samples E-H are crosslinked (30 s exposure time) using a 600 W/in H-type mercury UV lamp fitted with a parabolic (non-focused) reflector. A single smaller circular film was sectioned and weighed. The film is oxidized in a convection oven at 250° C. for 10 hours under air environment (21% oxygen content). The film is weighed after air oxidation. Mass retention during air oxidation (oxidation mass yield) is reported in Table IX. Oxidized films are then carbonized in nitrogen environment from 25° C. to 800° C. using a ramp rate of 10° C./min. Mass retention during carbonization (carbonization mass yield) is reported in Table IX. Calculated overall mass yield is reported in Table IX.

TABLE VIII

| Example | Esacure One (phr) | Boric Acid (phr) |
|---|---|---|
| A | — | 1.01 |
| B | — | 1.01 |
| C | — | 5.26 |
| D | — | 5.26 |
| E | 2.06 | 1.03 |
| F | 2.06 | 1.03 |
| G | 2.15 | 5.38 |
| H | 2.15 | 5.38 |

TABLE IX

| | Oxidation Mass | Carbonization | Overall Mass |
|---|---|---|---|
| Example | yield (%) | Mass yield (%) | Yield (%) |
| A | 72.40 | 41.02 | 29.70 |
| B | 66.10 | 43.81 | 28.96 |
| C | 82.65 | 50.01 | 41.33 |
| D | 83.88 | 41.02 | 34.41 |
| E | 66.36 | 52.66 | 34.94 |
| F | 63.15 | 53.82 | 33.99 |
| G | 79.09 | 47.12 | 37.27 |
| H | 71.66 | 52.76 | 37.81 |

It is observed that mean oxidation mass yield of A-D (Example 3) increases by 31.6-58.2% when a fabricated article of polyethylene-co-acrylic acid polymer resin containing 9.7 wt % acid melt blended with varying boric acid loadings are air oxidized when compared with Comparative Example 3A. It is also observed that mean overall mass yield of A-D (Example 3) increases by 28.3-65.7% when a fabricated article of polyethylene-co-acrylic acid polymer resin containing 9.7 wt % acid melt blended with varying boric acid loadings are air oxidized and carbonized when compared with Comparative Example 3A. It is additionally observed that mean oxidation mass yield of E-H (Example 3) increases by 23.1-43.2% when a crosslinked film of polyethylene-co-acrylic acid polymer resin containing 9.7 wt % acid melt blended with a suitable photoinitiator and varying boric acid loadings are air oxidized when compared with Comparative Example 3A. It is also observed that mean carbonization mass yield of E-H (Example 3) increases by 14.9-22.5% when an oxidized crosslinked film of polyethylene-co-acrylic acid polymer resin containing 9.7 wt % acid melt blended with a suitable photoinitiator and varying boric acid loadings are carbonized when compared with Comparative Example 3A. It is still further observed that mean overall mass yield of E-H (Example 3) increases by 50.8-64.2% when a crosslinked film of polyethylene-co-acrylic acid polymer resin containing 9.7 wt % acid melt blended with a suitable photoinitiator and varying boric acid loadings are air oxidized and carbonized when compared with Comparative Example 3A.

### Comparative Example 4

A polyethylene-co-acrylic acid polymer resin containing 20.5 wt % acid (density=0.958 g/cm³; MI=14 g/10 min, 125° C./2.16 kg) is compression molded at 130° C. to form thin films measuring 3 millimeters (76.2 microns) thick by micrometer. A single smaller circular film is sectioned from the film and weighed. The film is oxidized in a convection oven at 250° C. for 10 hours under air environment (21% oxygen content). The film is weighed after air oxidation. Mass retention during air oxidation (oxidation mass yield) is reported in Table X. The oxidized film is then carbonized in a nitrogen environment from 25° C. to 800° C. using a ramp rate of 10° C./min. Mass retention during carbonization (carbonization mass yield) is reported in Table X. Calculated overall mass yield is reported in Table X.

TABLE X

| | Oxidation Mass | Carbonization | Overall Mass |
|---|---|---|---|
| Example | Yield (%) | Mass Yield (%) | Yield (%) |
| A | 77.25 | 7.40 | 5.71 |

### Example 4

A polyethylene-co-acrylic acid polymer resin containing 20.5 wt % acid (density=0.958 g/cm³; MI=14 g/10 min, 125° C./2.16 kg) is melt blended with varying portions of boric acid and Esacure ONE, a commercially available photoinitiator sold by Lambeth, at 175° C. in a Haake mixer under nitrogen. Table XI reports the additive loadings. Suitable films are compression molded at 130° C. to form thin films measuring 3 millimeters (76.2 microns) thick by micrometer. Samples A-D received no additional treatment. Samples E-H are crosslinked (30 s exposure time) using a 600 W/in H-type mercury UV lamp fitted with a parabolic (non-focused) reflector. A single smaller circular film is sectioned from treated samples and weighed. The film is oxidized in a convection oven at 250° C. for 10 hours under air environment (21% oxygen content). The film is weighed after air oxidation. Mass retention during air oxidation (oxidation mass yield) is reported in Table XII. Oxidized films are then carbonized in nitrogen environment from 25° C. to 800° C. using a ramp rate of 10° C./min. Mass retention during carbonization (carbonization mass yield) is reported in Table XII. Calculated overall mass yield is reported in Table XII.

TABLE XI

| Example | Esacure One (phr) | Boric Acid (phr) |
|---|---|---|
| A | — | 1.01 |
| B | — | 1.01 |
| C | — | 5.26 |
| D | — | 5.26 |
| E | 2.06 | 1.03 |
| F | 2.06 | 1.03 |
| G | 2.15 | 5.38 |
| H | 2.15 | 5.38 |

TABLE XII

| | Oxidation Mass | Carbonization | Overall Mass |
|---|---|---|---|
| Example | Yield (%) | Mass Yield (%) | Yield (%) |
| A | 69.37 | 28.08 | 19.48 |
| B | 71.41 | 31.88 | 22.77 |
| C | 75.20 | 35.00 | 26.32 |
| D | 80.74 | 20.06 | 16.20 |
| E | 58.06 | 53.41 | 31.01 |
| F | 60.88 | 51.82 | 31.55 |
| G | 68.09 | 55.42 | 37.74 |
| H | 68.96 | 53.30 | 36.76 |

It is observed that mean carbonization mass yield of A-D (Example 4) increases by 272-305% (3.7-4.1 fold increase) when formed films of polyethylene-co-acrylic acid polymer resin containing 20.5 wt % acid melt blended with varying boric acid loadings are air oxidized and carbonized when compared with Comparative Example 4A. It is also observed that mean overall mass yield of A-D (Example 4) increases by 271% when formed films of polyethylene-co-acrylic acid polymer resin containing 20.5 wt % acid melt blended with varying boric acid loadings are air oxidized and carbonized when compared with Comparative Example 4A. It is additionally observed that mean carbonization mass yield of E-H (Example 4) increases 448-552% relative increase (5.5-6.5 fold increase) when a crosslinked film of polyethylene-co-acrylic acid polymer resin containing 20.5 wt % acid melt blended with a suitable photoinitiator and varying boric acid loadings are air oxidized and carbonized when compared with Comparative Example 4A. It is still further observed that mean overall mass yield of E-H (Example 4) increases 611-635% (7.11-7.4 fold increase) when a crosslinked film of polyethylene-co-acrylic acid polymer resin containing 20.5 wt % acid melt blended with a suitable photoinitiator and varying boric acid loadings are air oxidized and carbonized when compared with Comparative Example 4A.

### Comparative Example 5

A poly(ethylene-co-vinyl acetate) resin purchased from Sigma Aldrich (18 wt % vinyl acetate, MI=8 g/10 min (190° C./2.16 kg), containing 200-900 ppm butylated hydroxytoluene, BHT, as inhibitor) is melt blended with 2.06 phr Esacure ONE, a commercially available photoinitiator sold by Lamberti, and a 1.03 phr of a multi-vinyl enhancer, pentaerythritol tetraacrylate (PETA) at 180° C. in a Haake blender under nitrogen atmosphere. Suitable films are compression molded at 150° C. to form thin films measuring ˜3 mils (76.2 microns) by micrometer. Films are crosslinked (30 s exposure time) using a 600 W/in H-type mercury UV lamp fitted with a parabolic (non-focused) reflector. Two (2) smaller circular films are sectioned from the prepared films and weighed. The films are oxidized in a convection oven at 260° C. for 10 hours under air environment (21% oxygen content). The films are weighed after air oxidation. Mass retention during air oxidation (oxidation mass yield) is reported in Table XIII Oxidized films are then carbonized in nitrogen environment from 25° C. to 800° C. using a ramp rate of 10° C./min Mass retention during carbonization (carbonization mass yield) is reported in Table XIII. Calculated overall mass yield is reported in Table XIII.

TABLE XIII

| | Oxidation mass | Carbonization | Overall Mass |
|---|---|---|---|
| Example | yield (%) | mass yield (%) | Yield (%) |
| A | 42.42 | 51.50 | 21.8 |
| B | 43.99 | 45.38 | 20.0 |

### Example 5

A poly(ethylene-co-vinyl acetate) resin available from Sigma Aldrich (18 wt % vinyl acetate, MI=8 g/10 min (190° C./2.16 kg), containing 200-900 ppm butylated hydroxytoluene, BHT, as inhibitor) is melt blended with 2.17 phr Esacure ONE, a commercially available photoinitiator sold by Lamberti, 1.09 phr of a multi-vinyl enhancer, pentaerythritol tetraacrylate (PETA), and 5.43 phr boric acid at 180° C. in a Haake blender under nitrogen atmosphere. Suitable films are compression molded at 150° C. to form thin films measuring ˜3 millimeters (76.2 microns) thick by micrometer. Films are crosslinked (30 s exposure time) using a 600 W/in H-type mercury UV lamp fitted with a parabolic (non-focused) reflector. Two (2) smaller circular films are sectioned from the prepared films and weighed. The films are oxidized in a convection oven at 260° C. for 10 hours under air environment (21% oxygen content). The films are weighed after air oxidation. Mass retention during air oxidation (oxidation mass yield) is reported in Table XIV. Oxidized films are then carbonized in nitrogen environment from 25° C. to 800° C. using a ramp rate of 10° C./min. Mass retention during carbonization (carbonization mass yield) is reported in Table XIV. Calculated overall mass yield is reported in Table XIV.

TABLE XIV

| | Oxidation mass | Carbonization | Overall Mass |
|---|---|---|---|
| Example | yield (%) | mass yield (%) | Yield (%) |
| A | 65.11 | 48.10 | 31.3 |
| B | 62.99 | 56.02 | 35.3 |

It is observed that mean oxidation mass yield of A-B (Example 5) increases by 48.3% when UV-crosslinked films of poly(ethylene-co-vinyl acetate) are melt blended with boric acid and are oxidized when compared to A-B (Comparative Example 5). It is further observed that mean overall mass yield of A-B (Example 5) increases by 59.3% when UV-crosslinked films of poly(ethylene-co-vinyl acetate) are melt blended with boric acid and are oxidized and carbonized when compared to A-B (Comparative Example 5).

### Comparative Example 6

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Gel fraction is determined to be 27.9% by hot xylenes extraction. Two (2) smaller circular films are sectioned from the prepared films and weighed. Films are oxidized in a convection oven at 270° C. for 5 hours under air environment (21% oxygen content). The two (2) films are weighed after air oxidation. Mass retention during air oxidation (oxidation mass yield) is reported in Table XV. Oxidized films are then carbonized in nitrogen environment from 25° C. to 800° C. using a ramp rate of 10° C./min. Mass retention during carbonization (carbonization mass yield) is reported in Table XV. Calculated overall mass yield is reported in Table XV.

TABLE XV

| | Oxidation Mass | Carbonization | Overall Mass |
|---|---|---|---|
| Example | Yield (%) | Mass Yield (%) | Yield (%) |
| A | 33.79 | 45.59 | 15.40 |
| B | 34.77 | 45.34 | 15.76 |

### Example 6

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) and varying portions of boric acid, as reported in Table XVI, at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Two (2) smaller circular films for each boric acid loading are sectioned from the prepared films and weighed. Films are oxidized in a convection oven at 270° C. for 5 hours under air environment (21% oxygen content). Two (2) films are weighed after air oxidation. Mass retention during air oxidation (oxidation mass yield) is reported in Table XVII. Oxidized films were then carbonized in nitrogen environment from 25° C. to 800° C. using a ramp rate of 10° C./min. Mass retention during carbonization (carbonization mass yield) is reported in Table XVII. Calculated overall mass yield and overall PE mass yield is reported in Table XVII.

TABLE XVI

| Example | Esacure One (phr) | Boric Acid (phr) |
|---|---|---|
| A | 2.04 | 10.20 |
| B | 2.04 | 10.20 |
| C | 2.04 | 20.41 |
| D | 2.04 | 20.41 |
| E | 2.04 | 30.61 |
| F | 2.04 | 30.61 |

TABLE XVII

| | | | | Overall |
|---|---|---|---|---|
| | Oxidation Mass | Carbonization | Overall Mass | PE Mass |
| Example | Yield (%) | Mass Yield (%) | Yield (%) | Yield (%) |
| A | 82.79 | 42.61 | 35.28 | 38.81 |
| B | 82.98 | 45.64 | 37.87 | 41.66 |
| C | 83.66 | 45.14 | 37.76 | 45.31 |
| D | 84.50 | 48.91 | 41.33 | 49.60 |
| E | 77.11 | 60.54 | 46.68 | 60.69 |
| F | 76.79 | 57.87 | 44.44 | 57.77 |

It is observed that mean oxidation mass yield of A-F (Example 6) increases by 124-145% (2.2-2.5 fold increase) when crosslinked films of polyethylene are melt blended with varying loadings of boric acid are oxidized when compared to A-B (Comparative Example 6). Further, it is observed that mean overall mass yield of A-F (Example 6) increases by 135-192% (2.4-2.9 fold increase) when crosslinked films of polyethylene melt blended with varying loadings of boric acid are oxidized and carbonized when compared to A-B (Comparative Example 6).

### Comparative Example 7

A high density polyethylene resin, Microthene F FA70000 (density=0.952 g/cm³; MI=10 g/10 min, 190° C./2.16 kg, average particle size=20 microns) from LyondellBasel is dry blended with Esacure ONE, a commercially available photoinitiator sold by Lambeth, at 2.0 phr. Films are compression molded using a Carver press at 180° C. into thin films measuring 3 millimeters (76.2 microns) thick by micrometer. All films are crosslinked (30 s exposure time per side) using a 300 W/in H-type mercury UV lamp fitted with a parabolic (non-focused) reflector. Six (6) smaller circular films are sectioned from the prepared films and weighed. Films are oxidized in a convection oven at 270° C. for 5 hours under air environment (21% oxygen content). Six (6) films are weighed after air oxidation. Mass retention during air oxidation (oxidation mass yield) is reported in Table XVIII. Oxidized films are then carbonized in nitrogen environment from 25° C. to 800° C. using a ramp rate of 10° C./min. Mass retention during carbonization (carbonization mass yield) is reported in Table XVIII. Calculated overall mass yield and overall PE mass yield is reported in Table XVIII.

TABLE XVIII

| | Oxidation Mass | Carbonization | Overall Mass |
|---|---|---|---|
| Example | Yield (%) | Mass Yield (%) | Yield (%) |
| A | 44.57 | 32.06 | 14.29 |
| B | 45.44 | 31.23 | 14.19 |
| C | 39.20 | 42.37 | 16.61 |
| D | 41.96 | 34.35 | 14.41 |
| E | 42.04 | 32.89 | 13.83 |
| F | 41.48 | 27.95 | 11.59 |

### Example 7

A high density polyethylene resin, Microthene F FA70000 (density=0.952 g/cm3; MI=10 g/10 min, 190° C./2.16 kg, average particle size=20 microns) from LyondellBasel is dry blended with Esacure ONE, a commercially available photoinitiator sold by Lambeth, at 2.0 phr and the BCS reported in Table XIX. Each BCS is milled with a Wig-L-Bug to reduce particle size prior to dry blending. Films are compression molded for each formulation using a Carver press at 180° C. into thin films measuring 3 millimeters (76.2 microns) thick by micrometer. All films are crosslinked (30 s exposure time per side) using a 300 W/in H-type mercury UV lamp fitted with a parabolic (non-focused) reflector. Smaller circular films are sectioned from the prepared films and weighed for each BCS. Films are oxidized in a convection oven at 270° C. for 5 hours under air environment (21% oxygen content). Each film is weighed after air oxidation. Mass retention during air oxidation (oxidation mass yield) is reported in Table XX. Each film is then carbonized in nitrogen environment from 25° C. to 800° C. using a ramp rate of 10° C./min Mass retention during carbonization (carbonization mass yield) is reported in Table XX. Calculated overall mass yield and overall PE mass yield is reported in Table XX.

TABLE XIX

| | | | BCS Loading |
|---|---|---|---|
| Example | Esacure One (phr) | BCS | (phr) |
| A | 2.0 | Phenylboronic | 5.0 |
| | | acid | |
| B | 2.0 | Phenylboronic | 5.0 |
| | | acid | |
| C | 2.0 | Boric acid | 5.0 |
| D | 2.0 | Boric acid | 5.0 |
| E | 2.0 | Boron oxide | 5.0 |
| F | 2.0 | Boron | 5.0 |
| G | 2.0 | Boron | 5.0 |
| H | 2.0 | Ammonium | 5.0 |
| | | pentaborate | |
| I | 2.0 | Ammonium | 5.0 |
| | | pentaborate | |
| J | 2.0 | Ammonium | 5.0 |
| | | tetraphenylborate | |
| K | 2.0 | Ammonium | 5.0 |
| | | tetraphenylborate | |

TABLE XX

| | Oxidation Mass | Carbonization | Overall Mass |
|---|---|---|---|
| Example | Yield (%) | Mass Yield (%) | Yield (%) |
| A | 52.63 | 45.42 | 23.91 |
| B | 51.05 | 51.44 | 26.26 |
| C | 61.06 | 43.06 | 26.29 |
| D | 64.42 | 45.37 | 29.23 |
| E | 49.85 | 58.73 | 29.28 |
| F | 53.01 | 56.50 | 29.95 |
| G | 58.46 | 62.63 | 36.62 |
| H | 71.90 | 54.04 | 38.85 |
| I | 70.03 | 44.33 | 31.04 |
| J | 42.09 | 49.99 | 21.04 |
| K | 43.69 | 50.28 | 21.97 |

It is observed that mean oxidation mass yield of A-K (Example 7) increases by 1-67% when crosslinked films of polyethylene are melt blended with various BCS are oxidized when compared to A-F (Comparative Example 7). Further, it is observed that mean carbonization mass yield of A-K (Example 7) increases by 32-78% (1.5-1.8 fold increase) when crosslinked films of polyethylene melt blended with various BCS are oxidized and carbonized when compared to A-F (Comparative Example 7). Still further, it is observed that mean overall mass yield of A-K (Example 7) increases by 52-147% (1.5-2.5 fold increase) when crosslinked films of polyethylene melt blended with various BCS are oxidized and carbonized when compared to A-F (Comparative Example 7). Complete relative mass yield improvements are reported in Table XXI.

TABLE XXI

| | Relative Improvement | | |
|---|---|---|---|
| | Oxidation Mass | Carbonization | Overall Mass |
| BCS | Yield (%) | Mass Yield (%) | Yield (%) |
| Phenylboronic | 22.1 | 44.7 | 77.2 |
| acid | | | |
| Boric acid | 47.8 | 32.1 | 96.1 |
| Boron oxide | 17.4 | 75.4 | 106.9 |
| Boron | 31.3 | 77.9 | 135.2 |
| Ammonium | 67.2 | 46.9 | 146.9 |
| pentaborate | | | |
| Ammonium | 1.0 | 49.8 | 51.9 |
| tetraphenylborate | | | |

What is claimed is:

1. A method for preparing a carbonized article comprising:
(a) providing an olefin resin;
(b) melt blending the olefin resin with a boron-containing species (BCS);
(c) forming a fabricated article;
(d) crosslinking the fabricated article;
(e) stabilizing the fabricated article of step (d) by air oxidation; and
(f) carbonizing the fabricated article of step (e).

2. The method of claim 1, wherein the BCS is a boron source suitable for depositing boron in the fabricated article.

3. The method of claim 2, wherein the boron source is an organoborane, boric acid, a derivative of boric acid, a derivative of boronic acid, a derivative of borinic acid, a substituted borinic acid, a derivative of borane, a derivative of boronic ester, a derivative of boroxine, elemental boron a derivative of borazine, a derivative of borohydride, or a derivative of aminoborane.

4. The method claim 1, wherein step (d) comprises heating the fabricated article at or above 120° C.

5. The method of claim 1, wherein step (c) comprises converting said polyolefin resin to a fabricated article by fiber spinning, film extrusion casting, blown film processing, profile extrusion through a die, injection molding, solution casting or compression molding.

6. A method for preparing a stabilized article comprising:
(c) providing an olefin resin;
(d) melt blending the olefin resin with a boron-containing species (BCS);
(c) forming a fabricated article;
(d) crosslinking the fabricated article; and
(e) stabilizing the fabricated article of step (d) by air oxidation.

7. The method of claim 6, wherein the BCS is a boron source suitable for depositing boron in the fabricated article.

8. The method of claim 7, wherein the boron source is an organoborane, boric acid, a derivative of boric acid, a derivative of boronic acid, a derivative of borinic acid, a substituted borinic acid, a derivative of borane, a derivative of boronic ester, a derivative of boroxine, elemental boron a derivative of borazine, a derivative of borohydride, or a derivative of aminoborane.

9. The method claim 6, wherein step (d) comprises heating the fabricated article at or above 120° C.
